(19) United States
(12) Patent Application Publication
(10) Pub. No.: US 2007/0119317 A1
(43) Pub. Date: May 31, 2007

(54) Recording Medium Conveying Mechanism And Image Recording Device Including The Same

(75) Inventor: Osamu Takagi, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/562,659

(22) Filed: Nov. 22, 2006

(30) Foreign Application Priority Data
Nov. 28, 2005 (JP) 2005-341469

(51) Int. Cl. B41F 13/56

(52) U.S. Cl. 101/227

(57) ABSTRACT

A recording medium conveying mechanism has a conveyor, a cutter, a decurler, and a driver. The conveyor conveys a rolled recording medium while drawing out the recording medium from one end thereof. The cutter cuts the recording medium in a predetermined length. The decurler corrects curl set in the recording medium. The driver drives the cutter and the decurler so that the decurler corrects the curl in association with a cutting operation by the cutter.

### BACKGROUND OF THE INVENTION

1. Field of the Invention

The present invention relates to a recording medium conveying mechanism that conveys a recording medium wound in a roll shape while drawing out the recording medium from one end thereof, and an image recording medium including the recording medium conveying mechanism.

2. Description of Related Art

In an image recording device such as an ink-jet printer or the like, rolled recording paper is drawn out from one end thereof, and conveyed to a recording head to be recorded. The reason for use of the rolled recording paper is to prevent occurrence of a useless margin on the recording paper when an image having an indefinite size is recorded.

When the rolled recording paper is used, curl is set in the recording paper because the recording paper is accommodated in a rolled state. When the recording paper is conveyed with the curl set therein, the recording paper comes into contact with each member in the device, which may induce troubles in conveying the recording paper and/or recording on the recording paper. For example, when a leading edge of the recording paper in a conveying direction where the paper is conveyed is curled upwardly, the leading edge abuts against the recording head, and paper jam may occur. Particularly when the recording paper is cut out in a predetermined length before it reaches the recording head, if the leading edge of a cut sheet formed by cutting in the conveying direction is curled, the cut sheet is floated from a recording paper support face of a belt, a platen or the like, and thus the recording paper cannot be excellently conveyed, so that the recording quality is degraded.

There is known a technique of correcting curl set in recording paper by providing a decurler (see JP-A-2000-226143) In this technique, the decurler includes a cylindrical member, and a peripheral surface of the cylindrical member is pressed against a surface of the recording paper so that the recording paper is curled in an opposite direction to a rolling direction of the recording paper, thereby correcting the curl set in the recording paper. After the curl set in the recording paper is corrected as described above, the recording paper is cut out by a predetermined length by a cutter and then recording is carried out on the cut sheet.

### SUMMARY OF THE INVENTION

In the above technique, after the curl set in the recording paper is corrected by the decurler, the recording paper is cut by the cutter. When the operations by the cutter and the decurler are separately carried out as described above, a time loss occurs between the operations, and thus it is difficult to perform a high-speed conveyance. Therefore, high-speed print which has been recently required to recording devices such as a printer cannot be implemented.

An object of the present invention is to provide a recording medium conveying mechanism that can convey a rolled recording medium at a high speed even when a decurler that corrects curl set in the recording medium is provided, and an image recording device including the record medium conveying mechanism.

According to a first aspect of the present invention, there is provided a recording medium conveying mechanism having a conveyor that conveys a rolled recording medium while drawing out the recording medium from one end thereof, a cutter that cuts the recording medium in a predetermined length, a decurler that corrects curl set in the recording medium, and a driver that drives the cutter and the decurler so that the decurler corrects the curl in conjunction with a cutting operation by the cutter.

According to another aspect of the present invention, there is provided an image recording device having a recording medium conveying mechanism that conveys a rolled recording medium and a recording head that records an image on the recording medium conveyed by the recording medium conveying mechanism. The recording medium conveying mechanism includes a conveyor that conveys the rolled recording medium while drawing out the recording medium from one end thereof, a cutter that cuts the recording medium in a predetermined length, a decurler that corrects curl set in the recording medium, and a driver that drives the cutter and the decurler so that the decurler corrects the curl in conjunction with a cutting operation by the cutter.

According to the first and second aspects, the operation by the cutter and the operation by the decurler are carried out substantially simultaneously with each other. Therefore, the time loss occurring when these operations are carried out separately from each other can be eliminated, and the recording medium can be conveyed at high speed. In the image recording device according to the second aspect, the high-speed recording can be implemented.

### BRIEF DESCRIPTION OF THE DRAWINGS

Other and further objects, features and advantages of the invention will appear more fully from the following description taken in connection with the accompanying drawings in which:

FIG. 1 is a front view showing an overall construction of an ink-jet printer according to an embodiment of the present invention;

FIG. 2 is a schematic diagram showing a cutter/decurler unit included in the ink-jet printer of FIG. 1;

FIG. 3 is a schematic diagram showing a modification of a drive mechanism for the cutter/decurler unit;

FIG. 4A is a schematic diagram showing a first modification of the cutter/decurler unit;

FIG. 4B is a cross-sectional view taken along B-B line of FIG. 4A;

FIG. 5A is a schematic diagram showing a second modification of the cutter/decurler unit;

FIG. 5B is a cross-sectional view taken along B-B line of FIG. 5A;

FIG. 5C is a cross-sectional view taken along C-C line of FIG. 5A; and

FIG. 6 is a cross-sectional view showing another example of an upper decurler of FIG. 5C.

### DESCRIPTION OF THE PREFERRED EMBODIMENTS

Preferred embodiments according to the present invention will be described hereunder with reference to the accompanying drawings.

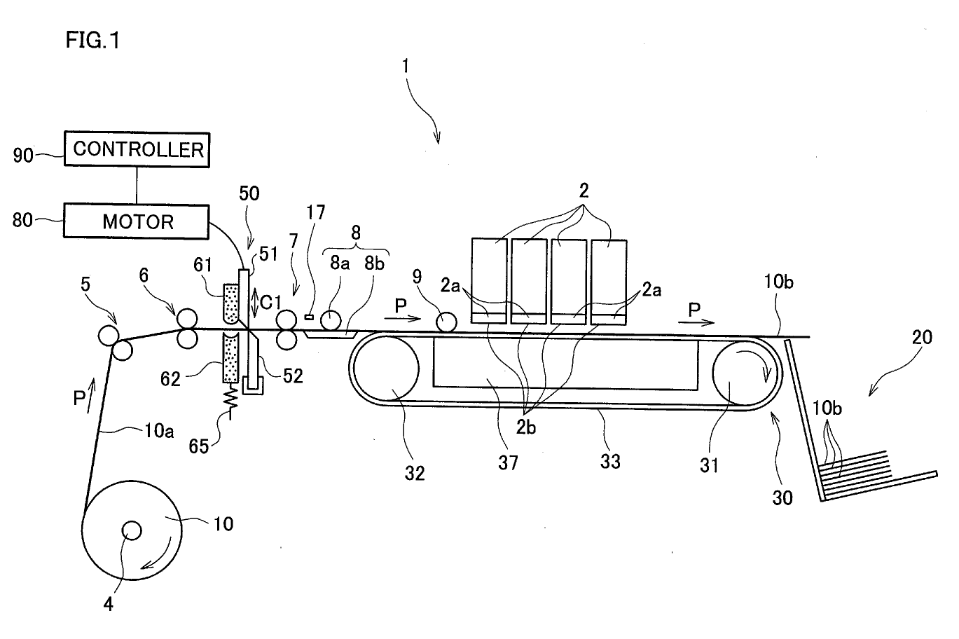

First, an embodiment of an image recording device according to the present invention will be described. In this embodiment, a line type color ink-jet printer 1 having four ink-jet heads 2 as shown in FIG. 1 is applied.

As shown in FIG. 1, a roll 10 achieved by winding elongated recording paper in a roll shape is accommodated in the printer 1. The roll 10 is supported on a shaft 4 so as to be rotatable clockwise in FIG. 1, and one end thereof is drawn out and conveyed along a conveying direction indicated by an arrow P of FIG. 1 while successively pinched by guide roller pairs 5, 6 and 7. Each of the guide roller pairs 5, 6 and 7 includes a pair of cylindrical members. The length of the cylindrical members is slightly longer than the width of recording paper 10a which is unrolled from the roll 10. The cylindrical members of a pair are disposed adjacently to each other, and one of the cylindrical members is rotated while the recording paper 10a is pinched between these cylindrical members, whereby the recording paper 10a is conveyed along the conveying direction P.

Curl is set in the recording paper 10a unrolled from the roll 10. In this embodiment, the curl of the recording paper 10a is set so that the recording paper 10a is convex toward a front surface thereof, that is, a print surface.

A cutter/decurler unit 50 is disposed between the guide roller pairs 6 and 7. The cutter/decurler unit 50 includes a movable blade 51 and a fixed blade 52 which are spaced from each other so as to sandwich the recording paper 10a therebetween, an upper decurler 61 fixed to the movable blade 51, and a lower decurler 62 which is disposed so as to confront the upper decurler 61 and be adjacent to the fixed blade 52. A cutting operation is carried out by the movable blade 51 and the fixed blade 52, and a curl correcting operation is carried out by the upper decurler 61 and the lower decurler 62.

The movable blade 51 has a blade inclined with respect to the horizontal direction. The movable blade 51 is disposed above a conveying passage of the recording paper 10a with the blade thereof facing downwardly. The fixed blade 52 has a blade inclined with respect to the horizontal direction as in the case of the movable blade 51. The fixed blade 52 is disposed below the conveying passage of the recording paper 10a with the blade thereof facing upwardly.

The upper decurler 61 and the lower decurler 62 are respectively disposed at an upstream of the movable blade 51 and the fixed blade 52 with respect to the conveying direction P. The upper decurler 61 is formed integrally with the movable blade 51, whereas the lower decurler 62 is not formed integrally with the fixed blade 52. The lower decurler 62 is provided independently of the fixed blade 52 so as to be slightly spaced from the fixed blade 52, and urged upwardly by a spring 65. The upper decurler 61 and the lower decurler 62 are formed of elastic material such as sponge or the like.

The lower surface of the upper decurler 61 which faces the lower decurler 62 and the upper surface of the lower decurler 62 which faces the upper decurler 61 are curved so as to be convex in an opposite direction to a direction of the curl set in the recording paper 10a. In this embodiment, the direction of the curl is set so that the recording paper 10 is convex toward the front surface. Thus, the lower surface of the upper decurler 61 and the upper surface of the lower decurler 62 are curved so as to be convex toward a back surface of the paper 10. The lower surface of the upper decurler 61 and the upper surface of the lower decurler 62 have curved shapes which are engagedly fitted to each other. As detailed later, the recording paper 10a is pinched by the lower surface and the upper surface.

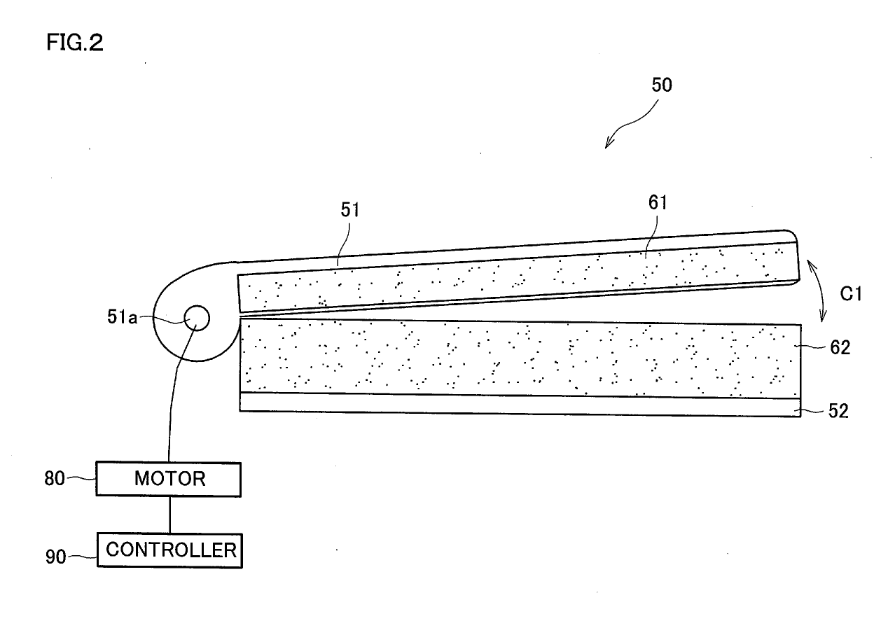

FIG. 2 is a view of the cutter/decurler unit 50 which is taken from the upstream with respect to the conveying direction P. As shown in FIG. 2, the movable blade 51, the fixed blade 52, the upper decurler 61, and the lower decurler 62 are provided so as to be elongated along a width direction of the recording paper 10a, and they are designed to be longer than the width of the recording paper 10a.

The movable blade 51 turns in the direction of an arrow C1 around a shaft 51a fixed to one end thereof. In association with this turning motion, the movable blade 51 moves relatively to the fixed blade 52, and the upper decurler 61 moves relatively to the lower decurler 62.

The movable blade 51 moves downwardly so that the blades of the movable blade 51 and the fixed blade 52 are overlapped with each other, whereby the recording paper 10a is cut out in the width direction. A portion of the recording paper 10a which is cut out by the cutting operation by the movable blade 51 and the fixed blade 52 and located at a downstream of the movable blade 51 and the fixed blade 52 with respect to the conveying direction P is conveyed as a cut sheet 10b to a conveying unit 30 below the head 2. After printed, cut sheets are successively laminated and accommodated in a sheet discharge tray 20.

The cutting timing of the recording paper 10a is controlled by a controller 90. A sensor 17 for detecting the recording paper 10a is disposed at the downstream of the guide roller pair 7 with respect to the conveying direction P. The controller 90 drives a motor 80 so as to rotate the shaft 51a fixed to the movable blade 51 on the basis of detection information from the sensor 17 and the recording paper conveying speed based on the guide roller pairs 5, 6, 7, etc. Thereby, the recording paper 10a is cut out in a predetermined length. The sensor 17 comprises an optical sensor including a light emitting element and a light receiving element, and detects the recording paper 10a on the basis of the difference in intensity of reflection light between the recording paper 10a and a sheet supply table 8b described later. The detection information from the sensor 17 is also used to determine, for example, the timing for starting a printing by the head 2.

Substantially at the same time when the cutting operation is carried out by the overlap of the blades of the movable blade 51 and the fixed blade 52, the upper decurler 61 is fitted to the lower decurler 62 while the recording paper 10a is pinched therebetween, thereby carrying out the curl correcting operation. A portion of the recording paper 10a where the curl is corrected is a portion serving as a leading edge in the conveying direction P when the recording paper 10a is cut by the movable blade 51 and the fixed blade 52.

A sheet supply unit 8 is disposed at the downstream of the guide roller pair 7 with respect to the conveying direction P. The sheet supply unit 8 includes a sheet supply roller 8a, a sheet supply table 8b, and a guide wall (not shown). The sheet supply roller 8a is disposed so that the outer peripheral surface thereof comes into contact with the surface of the recording paper 10a or the cut sheet 10b. The recording paper 10a and the cut sheet 10b will be hereinafter referred to as “sheet”. An upper surface of the sheet supply table 8b is disposed along the back surface of the sheet. The guide wall stands substantially vertically on the sheet supply table 8b and extends along the conveying direction P. In a plan view, a rotational shaft of the sheet supply roller 8a is not parallel to the sheet width direction but inclined by about 3° with respect to the sheet width direction.

When a sheet supply motor (not shown) is driven under the control of the controller 90 so that the sheet supply roller 8a is rotated, the sheet is conveyed along the conveying direction P while pressed against the sheet supply table 8b. At this time, the sheet is shifted to the guide wall because the rotational shaft of the sheet supply roller 8a is not parallel to the sheet width direction, but inclined with respect to the sheet width direction. One end of the sheet in the width direction comes into contact with the guide wall, whereby the sheet is set to be parallel to the conveying direction P. As described above, the inclination of the sheet is corrected before the sheet is printed.

The conveying unit 30 is disposed at the downstream of the sheet supply unit 8 with respect to the conveying direction P. The conveying unit 30 includes two belt rollers 31, 32, a loop-shaped conveying belt 33 suspended around both the rollers 31, 32, and a belt guide 37 having a substantially rectangular parallelepiped shape disposed in an area surrounded by the conveying belt 33. The belt guide 37 has substantially the same width as the conveying belt 33, and it is brought into contact with an inner peripheral surface of an upper loop of the conveying belt 33 to support the conveying belt 33.

The conveying belt 33 is formed of silicon rubber, EPDM (Ethylene Propylene Diene Monomer), urethane rubber, butyl rubber or the like, for example, and the outer peripheral surface thereof is formed of adhesive silicon rubber. Accordingly, the conveying belt 33 conveys a sheet with the sheet close contact with the outer peripheral surface of the conveying belt 33.

The belt roller 31 is a driving roller, and it is rotated in a clockwise direction of FIG. 1 by driving a conveying motor (not shown) under the control of the controller 90. Accordingly, the conveying belt 33 runs, and the other roller 32 serving as a driven roller is also rotated.

A press roller 9 is disposed at the downstream of the belt roller 32 with respect to the conveying direction P and at the upstream of the head 2 with respect to the conveying direction P so as to face the belt guide 37. The press roller 9 presses the sheet fed onto the conveying belt 33 against the conveying belt 33 before the sheet reaches the head 2, and enables the printing to be carried out under the state that the sheet surely comes into close contact with the outer peripheral surface of the conveying belt 33. A peeling plate (not shown) is disposed at the downstream of the head 2 with respect to the conveying direction P and before a sheet discharge tray 20. The sheet in close contact with the conveying belt 33 is peeled from the conveying belt 33 by the peeling plate, and then accommodated in the sheet discharge tray 20.

The four heads 2 are disposed adjacent to each other along the conveying direction P. Each head 2 has a head main body 2a at the lower end thereof, and a lower surface of the head main body 2a is designed as an ink ejection face 2b in which many openings (not shown) of a nozzle for ejecting ink are formed. The ink ejection face 2b is confronted to the outer peripheral surface of the conveying belt 33 through a slight gap interval. Ink of magenta, yellow, cyan and black is ejected from the ink ejection faces 2b of the four head main bodies 2a, respectively. The head main body 2a has a slender rectangular plane extending along a direction perpendicular to the drawing sheet of FIG. 1, that is, along a direction perpendicular to the conveying direction P. The head main body 2a has a length larger than the width of a sheet. When the sheet is moved through a space below the ink ejection faces 2b of the heads 2 in association with the running of the conveying belt 33 while supported on the conveying belt 33, color ink is ejected from the respective ink ejection faces 2b, whereby a desired color image is recorded on the sheet.

As described above, according to this embodiment, the cutting operation by the movable blade 51 and the fixed blade 52 and the curl correcting operation by the upper decurler 61 and the lower decurler 62 are carried out substantially simultaneously with each other. Therefore, the time loss occurring when these operations are carried out separately from each other can be nullified, and the sheet can be conveyed at high speed. Thus, the high speed printing can be implemented.

A portion of the recording paper 10a which is subjected to the curl correction while pinched between the upper and lower decurlers 61 and 62 serves as a leading edge in the conveying direction P when recording paper 10a is cut by the movable blade 51 and the fixed blade 52. When the portion of the recording paper 10a at the upstream of the cut portion of the recording paper 10a with respect to the conveying direction P, that is, the leading edge of the recording paper 10a in the conveying direction P is curled, the sheet is floated from the support face of the conveying belt 33 or the like, and thus the excellent conveyance cannot be performed. However, such a problem can be avoided by this embodiment.

In this embodiment, the movable blade 51 and the upper decurler 61 are driven through the motor 80 as a single driving source, and thus the construction can be more simplified and the cost can be more reduced as compared with a case where the movable blade 51 and the upper decurler 61 are provided with separate driving sources.

The simplification of the construction and the reduction of the cost can be implemented by forming the upper decurler 61 and the movable blade 51 integrally with each other.

The decurler of this embodiment includes the upper decurler 61 and the lower decurler 62 which are spaced from each other so as to sandwich the recording paper 10a therebetween. The upper and lower decurlers 61 and 62 are relatively moved and pinch the recording paper 10a to carry out the curl correction. The movable blade 51 and the fixed blade 52 carry out the same operation as the pinching operation of the recording paper 10a, and thus in the case of this construction, the cutting operation by the movable blade 51 and the fixed blade 52 and the operation by the decurler can be easily interlocked with each other.

The portions of the upper decurler 61 and the lower decurler 62 between which the recording paper 10a is pinched are curved in the opposite direction to the direction of the curl set in the recording paper 10a. Accordingly, as compared with a case where the portions concerned are flat, the curl correction can be more efficiently performed.

Both the upper decurler 61 and the lower decurler 62 are formed of elastic material such as sponge or the like, and thereby to achieve an effect that the curl correction is excellently performed without applying any inappropriate force to the recording paper 10a. Furthermore, the same effect can be achieved by urging the lower decurler 62 to the upper decurler 61 through the spring 65.

The cutter of this embodiment includes the fixed blade 52 and the movable blade 51 that are disposed so as to extend in the width direction of the recording paper 10a and spaced from each other so as to sandwich the recording paper 10a therebetween, and the upper decurler 61 is fixed to the movable blade 51 at the upstream with respect to the conveying direction P. In this case, the upper decurler 61 is moved in conjunction with the movement of the movable blade 51, so that the construction can be efficiently simplified, and the curl set in the leading edge in the conveying direction P of the recording paper 10a can be corrected immediately after the cutting operation, thereby excellently conveying the recording paper 10a.

The controller 90 of the ink-jet printer 1 controls the motor 80 so that the cutting operation by the cutter and the curl correction by the decurler are carried out before the sheet reaches the head 2. By cutting the sheet before print, the sheet is not wasted even when no-margin print is carried out, and it is unnecessary to rewind the sheet after print.

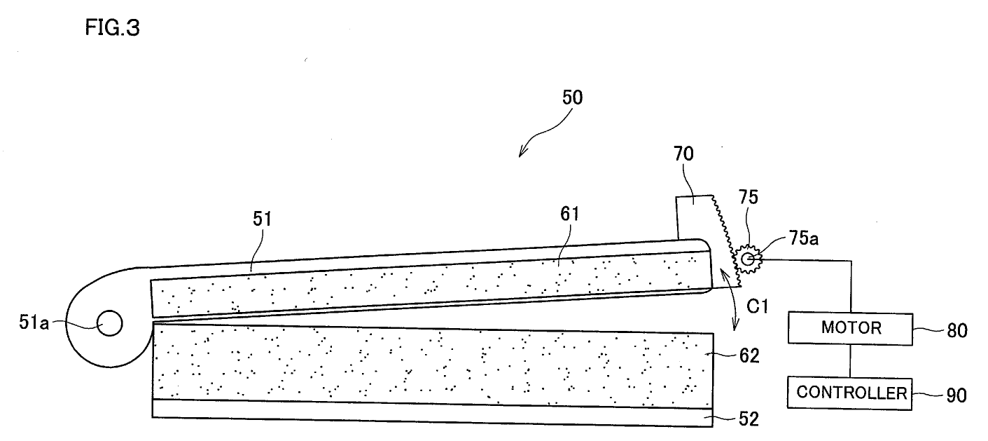

A drive mechanism for the cutter/decurler unit 50 is not limited to the one shown in FIG. 2. It may be one as shown in FIG. 3 for example. In a modification shown in FIG. 3, the shaft 51a is not fixed to the movable blade 51, but is fixed to a main body of the printer 1 while rotatably supporting the movable blade 51. A cutter holder 70 is fixed to the other end of the movable blade 51. An end face of the cutter holder 70 has a shape of arc centered about the shaft 51a. Teeth engageable with a gear 75 are formed on the end face of the cutter holder 70. The gear 75 rotates on and with a shaft 75a that is rotatably mounted to the main body of the printer 1. When the motor 80 is driven under control by the controller 90, the shaft 75a rotates in one direction and a reverse direction. The gear 75 rotates accordingly, so that the cutter holder 70 which is engaged with the teeth of the gear 75 swings on the shaft 51a in the direction of an arrow C1. As a consequence, the movable blade 51 moves relative to the fixed blade 52, and the upper decurler 61 moves relative to the lower decurler 62.

In the modification shown in FIG. 3, driving force of the motor 80 is, unlike in FIG. 2, not transmitted to the shaft 51a but to the shaft 75a of the gear 75. In this case, a torque required of the motor 80 is smaller than that in the construction shown in FIG. 2. Therefore, a small-size motor can be adopted.

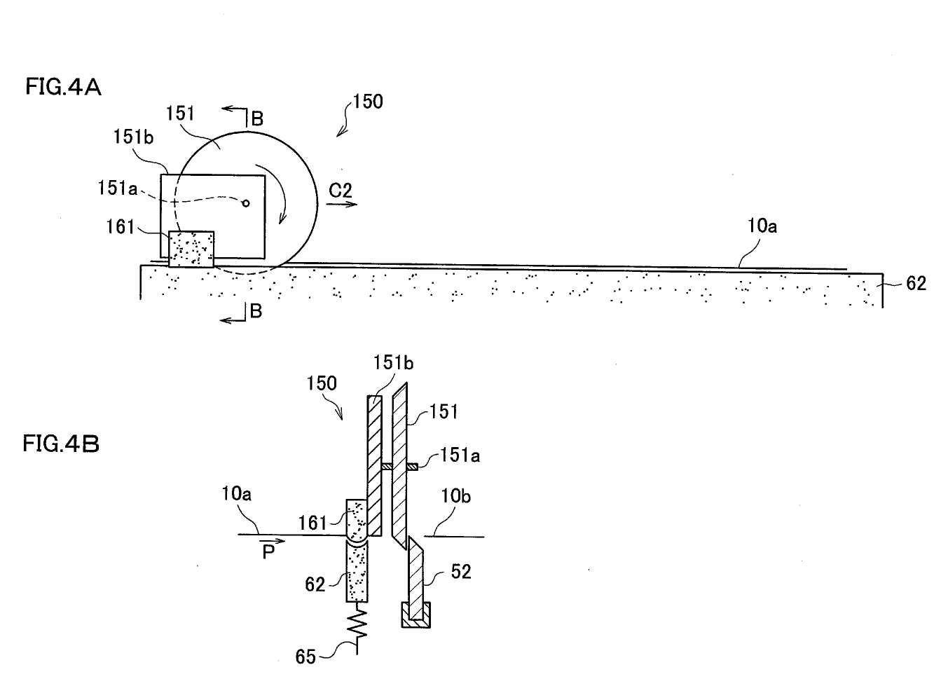

Next, a modification of the cutter/decurler unit will be described with reference to FIGS. 4A, 4B, 5A, 5B, 5C and 6.

FIGS. 4A and 4B show a first modification of the cutter/decurler unit. In a cutter/decurler unit 150 of this modification, the fixed blade 52 and the lower decurler 62 which are the same as the above-described embodiment are provided below the conveying passage of the recording paper 10a. In place of the movable blade 51 of the above-described embodiment, a circular blade 151 is provided above the conveying passage of the recording paper 10a.

The circular blade 151 is provided on a movable member 151b so as to be rotatable around a rotational shaft 151a erected along the conveying direction P. The circular blade 151 is moved in the direction of an arrow C2 in association with the movement of the movable member 151b in the width direction of the recording paper 10a, i.e., in the direction of the arrow C2, while clockwise rotating around the rotational shaft 151a. A lower part of the circular blade 151 is overlapped with the fixed blade 52 with respect to the conveying direction P. In association with the above movement, the recording paper 10a is successively cut from one end in the width direction thereof, i.e., from left in FIG. 4A.

An upper decurler 161 is fixed to a surface of the movable member 151b which faces the upstream in the conveying direction P. The upper decurler 161 can be moved integrally with the movable member 151b and the circular blade 151 in association with the movement of the movable member 151b in the direction of the arrow C2. As shown in FIG. 4A, the upper decurler 161 is provided at the upstream of the circular blade 151 with respect to the moving direction of the movable member 151b, i.e., the direction of the arrow C2, so as to be slightly overlapped with the circular blade 151 in the conveying direction P. As in the case of the upper decurler 61 of the above-described embodiment, the upper decurler 161 is formed of elastic material such as sponge or the like, and the lower surface thereof which faces the lower decurler 62 is curved in the opposite direction to the curl direction of the recording paper 10a.

According to this modification, the upper decurler 161 is moved in conjunction with the movement of the circular blade 151, whereby the construction can be efficiently simplified as in the case of the above-described embodiment. Furthermore, the upper decurler 161 is fixed to the upstream of the circular blade 151 with respect to the moving direction of the rotational shaft 151a, i.e., the direction of the arrow C2. Thus, the curl correction can be carried out on the leading edge in the conveying direction P of the recording paper 10a immediately after the cutting by the circular blade 151, so that the excellent conveyance can be performed.

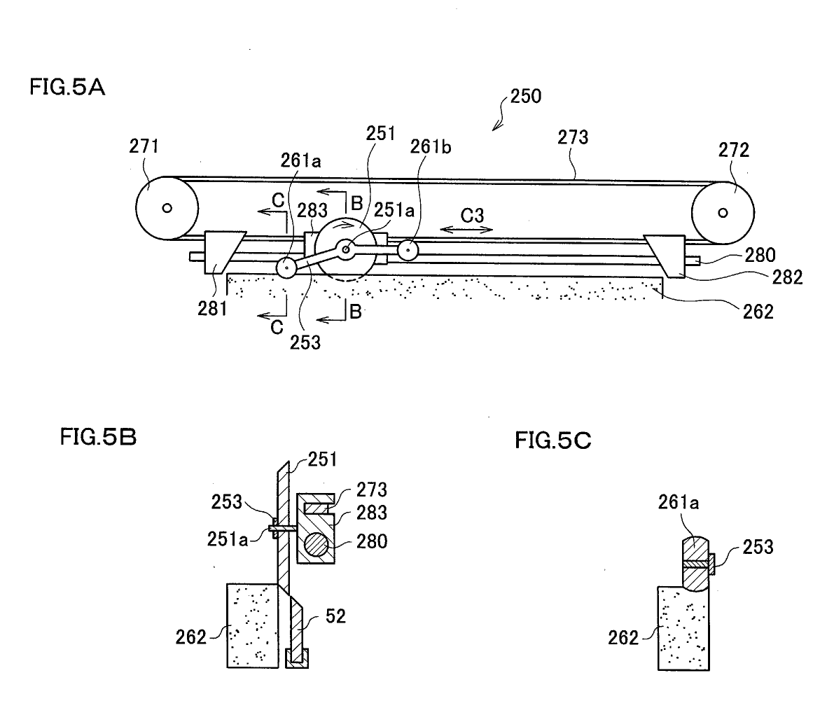

FIGS. 5A to 5C show a second modification of the cutter/decurler unit. In a cutter/decurler unit 250 of this modification, the same fixed blade 52 as the above-described embodiment and a decurler 262 which is different from the lower decurler 62 of the above-described embodiment only in that the upper surface is not curved but flat are provided below the conveying passage of the recording paper 10a. A circular blade 251 similar to the circular blade 151 of the first modification is provided above the conveying passage of the recording paper 10a.

The circular blade 251 has a rotational shaft 251a extending along the conveying direction P and moving along the width direction of the recording paper 10a, i.e., the direction of an arrow C3, similarly to the circular blade 151 of the first modification. As in the case of the circular blade 151 of the first embodiment, a lower part of the circular blade 251 is overlapped with the fixed blade 52 with respect to the conveying direction P, and in association with the movement described above, the recording paper 10a is successively cut from one end thereof in the width direction.

The circular blade 151 of the first embodiment is movable in only one direction from left to right in FIG. 4A, whereas the circular blade 251 of this modification is reciprocally movable from left to right and from right to left in FIG. 5A. After the circular blade 251 is moved from left to right, it is unnecessary to return the circular blade 251 to left again for the next cutting operation. In this case, the circular blade 251 may be temporarily stopped and then it is moved from right to left for the next cutting operation. When the circular blade 251 is moved from left to right as shown in FIG. 5A, the circular blade 251 is clockwise rotated around the rotational shaft 251a, and when the circular blade 251 is moved from right to left, the circular blade 251 is counterclockwise rotated around the rotational shaft 251a.

Upper decurlers 261a and 261b which are smaller than the circular blade 251 by one size are respectively provided at both sides of the circular blade 251 with respect to the width direction of the recording paper 10a. The upper decurler 261a and 261b are fixed to the circular blade 251 through an arm 253 fixed to the rotational shaft 251a. The upper decurler 261a and 261b are formed of a rigid material having little elasticity unlike the decurlers 61, 161.

The circular blade 251 is fixed to a carriage 283 through the rotational shaft 251a. A guide bar 280 extending in the width direction of the recording paper 10a penetrates through the carriage 283 so as to be slidable, and also a part of the lower loop of a timing belt 273 suspended between pulleys 271 and 272 is fixed to the carriage 283. When the timing belt 273 runs in association with the rotation of the pulleys 271, 272, the carriage 283 fixed to the timing belt 273 is moved in the direction of the arrow C3 while sliding along the guide bar 280. In association with the movement of the carriage 283, the circular blade 251 fixed to the carriage 283 is also moved.

Switching walls 281 and 282 are respectively fixed to the ends of the guide bar 280. A surface of each switching wall 281, 282 which faces the center in the width direction of the recording paper 10a is inclined so that as the position on the surface is higher in the vertical direction, it is nearer to the center in the width direction of the recording paper 10a. Under the state shown in FIG. 5A, the upper decurler 261a on the left is disposed at a lower position than the upper decurler 261b on the right so as to correct the curl set in the recording paper 10a. When the circular blade 251 is moved to the right under this state, the upper decurler 261b on the right is brought into contact with the switching wall 282 and further pressed downwardly while slid along the inclination surface of the switching wall 282. In association with this motion, the upper decurler 261a on the left rises. Substantially at the same time when the circular blade 251 finishes the movement from left to right in FIG. 5A, the decurler for correcting the curl is switched from the upper decurler 261a on the left to the upper decurler 261b on the right. When the circular blade 251 is moved from right to left in FIG. 5A, the upper decurler 261b on the right corrects the curl set in the recording paper 10a. Then, substantially at the same time when the circular blade 251 finishes the movement from right to left in FIG. 5A, the upper decurler 261a on the left is pressed downwardly by the switching wall 281 in the same manner as described above, whereby the decurler for correcting the curl is switched from the upper decurler 261b on the right to the upper decurler 261a on the left.

The peripheral surfaces of the upper decurlers 261a, 261b are curved so as to be convexed outwardly (the cross-section of the upper decurler 261a only is shown in FIG. 5C, however, the upper decurler 261b has the same cross-section). As described above, the upper decurlers 261a and 261b are formed of rigid material, and thus when the curl correction is carried out, the lower decurler 262 made of an elastic material is deformed in a concave shape by the press force of the upper decurlers 261a, 261b. Accordingly, as in the case of the example of FIG. 1, there can be performed the curl correction which is adapted to the case where the curl of the recording paper 10a is set so that the recording paper 10a is convex to the front surface thereof.

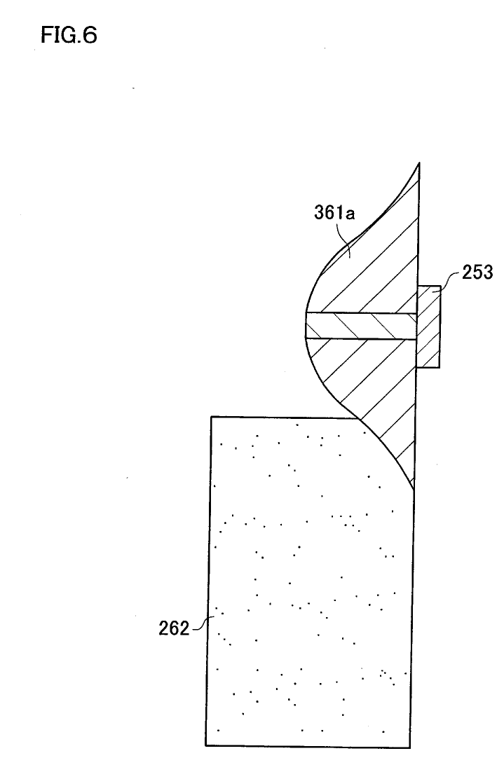

FIG. 6 shows another example of the upper decurler of FIG. 4C. An upper decurler 361a has a shape adapted to a case where the curl of the recording paper 10a is set so that the recording paper 10a is convex to the back surface thereof. A recess is formed on the peripheral surface of the upper decurler 361a, and by pressing the upper decurler 361a against the lower decurler 262, the lower decurler 262 is deformed in a convex shape. Accordingly, there can be performed the curl correction adapted to a case where the curl of the recording paper 10a is set so that the recording paper 10a is convex to the back surface thereof.

According to this modification, the upper decurlers 261a and 261b are respectively provided to both sides of the circular blade 251 with respect to the width direction of the recording paper 10a, and also the switching walls 281 and 282 are provided. Accordingly, as described above, after the circular blade 251 is moved from left to right in FIG. 5A to cut the recording paper 10a, in order to carry out the next cutting operation, the circular blade 251 is moved from right to left in FIG. 5A without returning the circular blade 251 to left in FIG. 5A. For example, in the first modification, the decurler 161 is provided to only one side of the circular blade 151 with respect to the width direction of the recording paper 10a, and also no switching mechanism like the switching walls 281 and 282 is provided. In such a case, in order to carry out the curl correction on the leading edge in the conveying direction P of the recording paper 10a immediately after the recording paper 10a is cut, it is required to fix the moving direction of the circular blade 151 at the direction of the arrow C2 so that the decurler 161 is located at the upstream of the circular blade 151 with respect to the moving direction, i.e., the direction of the arrow C2, at all times. That is, after the circular blade 151 is moved along the arrow C2 and cuts the recording paper 10a, the circular blade 151 must be returned to the home position on the left of FIG. 4 again in order to carry out the next cutting operation. On the other hand, according to this modification, the operation of returning the circular blade 251 to the home position every time the cutting operation is carried out can be omitted. Therefore, a high-speed conveyance can be more effectively performed.

The cutter that cuts the recording paper 10a is not limited to those described in the above-described embodiments and modifications, and various kinds of cutters may be applied.

The material of the decurler is not limited to a specific one, and various shapes and constructions may be adopted for the decurler.

The portion of the recording paper 10a on which the curl is corrected by the decurler is not limited to the portion serving as the leading edge in the conveying direction P when recording paper 10a is cut.

Different driving sources may be respectively provided to the cutters such as the movable blade 51 and the decurlers.

It is not necessary that the upper decurler 61 and the movable blade 51 are formed integrally with each other.

In the above embodiments, the lower decurler 62 is urged upwardly by the spring 65. However, the spring 65 may be omitted, and the lower decurler 62 may be fixed.

In FIG. 1, the cutter/decurler unit 50 is disposed at the upstream of the head 2 with respect to the conveying direction P, and the cutting operation by the cutter and the curl correction of the decurler are carried out before the sheet reaches the head 2. However, the present invention is not limited to this. For example, the cutter/decurler unit 50 may be disposed at the downstream of the head 2 with respect to the conveying direction P, and the cutting operation and the curl correcting operation may be carried out after the recording paper is printed by the head 2.

The image recording device of this invention is not limited to the line type ink-jet printer, and it may be applicable to a serial type ink-jet printer. Furthermore, the present invention is not limited to the printer, and it may be applied to a recording device such as a facsimile machine, a copying machine or the like. Still furthermore, the present invention is not limited to the ink-jet type recording device, and it may be applicable to various types of recording devices such as a laser type, etc.

The recording medium conveying mechanism of this invention maybe provided in any device in addition to the image recording device. The recording medium conveyed by the conveying mechanism is not limited to paper.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A recording medium conveying mechanism comprising:
a conveyor that conveys a rolled recording medium while drawing out the recording medium from one end thereof;
a cutter that cuts the recording medium in a predetermined length;
a decurler that corrects curl set in the recording medium; and
a driver that drives the cutter and the decurler so that the decurler corrects the curl in association with a cutting operation by the cutter.

2. The recording medium conveying mechanism according to claim 1, wherein the driver drives the decurler so as to correct the curl set in a portion of the recording medium, the portion serving as a leading edge in a conveying direction of the conveyor when the recording medium is cut by the cutter.

3. The recording medium conveying mechanism according to claim 1, wherein the driver has a single driving source.

4. The recording medium conveying mechanism according to claim 1, wherein the decurler is formed integrally with the cutter.

5. The recording medium conveying mechanism according to claim 1, wherein the decurler includes a first member and a second member which are disposed so as to be spaced from each other and sandwich the recording medium therebetween, and the first and second members are moved relatively to each other to pinch the recording medium, thereby correcting the curl.

6. The recording medium conveying mechanism according to claim 5, wherein portions of the first and second members of the decurler at which the recording medium is pinched are curved in an opposite direction to a direction of the curl set in the recording medium.

7. The recording medium conveying mechanism according to claim 5, wherein at least one of the first and second members is formed of elastic material.

8. The recording medium conveying mechanism according to claim 5, wherein at least one of the first and second members is urged toward the other member.

9. The recording medium conveying mechanism according to claim 5, wherein the cutter includes a fixed blade and a movable blade that are disposed so as to extend in a width direction of the recording medium and are spaced from each other so as to sandwich the recording medium therebetween, and one of the first and second members of the decurler is fixed to an upstream of the movable blade with respect to a conveying direction of the conveyor.

10. The recording medium conveying mechanism according to claim 9, wherein:
one end of the movable blade is rotatably supported on a shaft, and a holder is fixed to the other end of the movable blade;
the holder includes an end face of arc shape centered about the shaft, the end face having teeth engageable with a gear; and
the driver includes the holder, the gear, and a shaft of the gear, so that when the shaft of the gear is rotated by driving force of a single driving source, the movable blade rotates on the shaft.

11. The recording medium conveying mechanism according to claim 5, wherein the cutter includes a circular blade having a rotational shaft, which extends along a conveying direction of the conveyor and moves along a width direction of the recording medium, and one of the first and second members of the decurler is fixed at an upstream of the circular blade with respect to a moving direction of the rotational shaft.

12. The recording medium conveying mechanism according to claim 1, wherein the cutter includes a circular blade having a rotational shaft, which extends along a conveying direction of the conveyor and moves along a width direction of the recording medium, the decurler is provided to both sides of the cutter with respect to the width direction, and the recording medium conveying mechanism further includes a switching mechanism that switches in accordance with a moving direction of the rotational shaft which one of the decurlers corrects the curl.

13. An image recording device comprising:
a recording medium conveying mechanism that conveys a rolled recording medium; and
a recording head that records an image on the recording medium conveyed by the recording medium conveying mechanism, wherein the recording medium conveying mechanism comprises: a conveyor that conveys the rolled recording medium while drawing out the recording medium from one end thereof; a cutter that cuts the recording medium in a predetermined length; a decurler that corrects curl set in the recording medium; and a driver that drives the cutter and the decurler so that the decurler corrects the curl in association with a cutting operation by the cutter.

14. The image recording device according to claim 13, further comprising a controller that controls the driver so that the cutting operation by the cutter and a curl correcting operation by the decurler are carried out before the recording medium reaches the recording head.
